(19) United States
(12) Patent Application Publication
(10) Pub. No.: US 2022/0332010 A1
(43) Pub. Date: Oct. 20, 2022

(54) ISOSTATICALLY PRESSED PRODUCT FOR USE IN HANDLING OF MOLTEN METAL AND METHOD FOR PRODUCTION

(71) Applicant: REFRACTORY INTELLECTUAL PROPERTY GMBH & CO. KG, Wien (AT)

(72) Inventor: Hans-Jürgen HASLINGER, Trieben (AT)

(21) Appl. No.: 17/760,749

(22) PCT Filed: Oct. 8, 2020
(86) PCT No.: PCT/EP2020/078272

§ 371 Date: Mar. 15, 2022

(30) Foreign Application Priority Data
Oct. 10, 2019 (EP) 19202391.9

(51) Int. Cl. B28B 3/00; B22D 41/52; B22D 41/18

(52) U.S. Cl. CPC B28B 3/003; B22D 41/52; B22D 41/18

(57) ABSTRACT

An isostatically pressed product (10, 11, 12, 13, 14) for use in handling of molten metals comprising: a body (20) made from a first refractory composition (50); the body (20) comprises a surface (21); and at least one liner section (30.1) applied partially onto the surface (21) of the body (20); the at least one liner section (30.1) is made from a second refractory composition (51); the at least one liner section (30.1, 30.2) forming the liner (30) of the body (20); whereas in at least one cross-section of the product, the surface (21) of the body (20) in a region covered with the liner (30), comprises at least one convex (41) and at least two concave (42) sections and a method for manufacturing an isostatically pressed product (10, 11, 12, 13, 14) for use in handling of molten metals.

The invention relates to an isostatically pressed product for use in handling of molten metal, such as a stopper rod, or a refractory nozzle, e.g. a submerged entry nozzle, a submerged entry shroud, a ladle shroud or any other nozzle for connection with a tundish and a method for production of such a product.

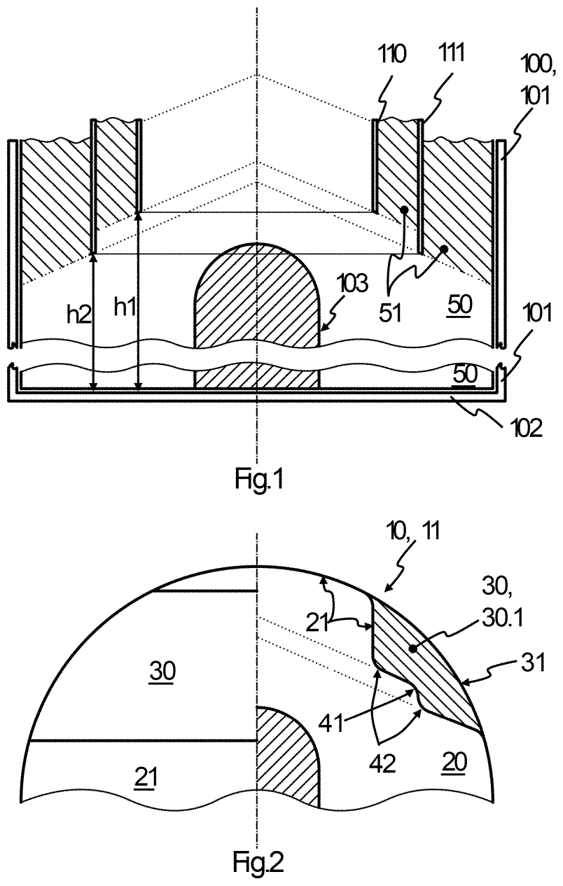

Isostatically pressed products for use in handling of molten metal, such as a stopper rod, or a refractory nozzle, e.g a submerged entry nozzle, a submerged entry shroud, a ladle shroud or any other nozzle for connection with a tundish generally comprise a body made from a refractory composition. Liner sections (also coating sections) can be applied at least partially onto the surface of the body, e.g. to protect the body from erosion due to the contact with the molten melt. Such products with a liner section are known e.g. from EP 0 721 388 B1 (there: couche 4, 10 in FIGS. 1 and 6). These liners are in the form of a layered structure, in the sense that their thickness does not vary. Such liners of changing thickness are e.g. known from WO 2006/007672 A2, where a layer has been co-pressed as a liner with the stopper body, the liner is constituted of several preformed tubular portions. Generally, such refractory products are often produced by the so called “isostatic pressing” method. To arrange two different materials for the body and the liner at least one of the materials need to be pre-compacted/pre-formed before the actual step of pressing. U.S. Pat. No. 4,323,529 discloses a sliding gate valve slide plate in a can that has an integral collector nozzle and is formed as two conjoined refractory concrete mouldings with a cup or trough shaped metal foil lying in the joint therebetween. JP H06 142899 discloses a lower nozzle, whereas the circumference of the molten steel flow hole (d) of such lower nozzle for casting the molten steel is constituted of the shaped refractories (c) and the circumference of the shaped refractories (c) is constituted of the monolithic refractories (b) to form a two-layered construction.

The inventor has realized, that for a good adhesion of such a liner, the interface area between the liner and the body should be “interlocked”. Especially curved interface surfaces or interfaces with stepped surfaces lead to a good mechanical stability of the liner and the body. In the case of production by isostatic pressing, the inventor has found that shorter production times can be achieved, when using removable division walls (of the mold filling device), while simultaneously an interlocked interface surface is achieved, such that a good adhesion is achieved. Additionally, the inventors have realized, that it is important for a good adhesion between body and liner, that the materials of the body and the liner are loose materials before being pressed together. A pre-compaction before pressing the product for use in molten metal should be avoided. In many geometries it is impossible according to the prior art to arrange two different materials according to the targeted geometry without a pre-compaction of one of the materials. By avoiding a pre-compaction, a better homogeneity of the pressed body can be achieved in the interface region and the adhesion of the liner is increased, therefor good mechanical properties are achieved.

Therefore, it is an object of the present invention to provide an isostatically pressed product for use in handling of molten metal, such as a stopper rod, or a refractory nozzle, such as a submerged entry nozzle, a submerged entry shroud, a ladle shroud, or any other nozzle for connection with a tundish whereas the isostatically pressed product comprises a liner section on the surface of the body.

It is a further object of the invention, to provide an isostatically pressed product for use in handling of molten metal, whereas the isostatically pressed product comprises a liner section on the surface of the body, and whereas the liner section shows high adhesion to the body, leading to good mechanical properties.

It is a further object of the present invention to provide a method for production of a product for use in handling of molten metal, such as a stopper rod, or a refractory nozzle, whereas the production is simple and reliable.

The object is achieved by providing an isostatically pressed product for use in handling of molten metal according to claim 1 and a method for manufacturing a product for use in handling of molten metal according to claim 9 with a resulting product according to claim 15. The advantages and refinements mentioned in connection with the method also apply analogously to the products/physical objects and vice versa.

The core idea of the invention is based on the finding that the adhesion of a liner to a body of an isostatically pressed product for use in molten steel can be high by providing an interlocked (e.g specially curved or stepped) interface surface between the liner and the body. Also, the production can be achieved in a single step, avoiding any pre-compaction of materials.

In a first embodiment, the object is achieved by an isostatically pressed product for use in handling of molten metals comprising:

a) a body made from a first refractory composition;

b) the body comprises a surface;

c) and at least one liner section applied partially onto the surface of the body; the at least one liner section is made from a second refractory composition;

d) and optionally further liner sections such as a second liner section applied partially onto the surface of the body; the second liner section is made from a third refractory composition;

e) the at least one liner section/all liner sections forming the liner of the body;

f) whereas in at least one cross-section of the product, the surface of the body in a region covered with the liner (this is the interface surface), comprises at least one convex and at least two concave sections (as seen from the body);

and whereas the product for use is an isostatically pressed product. It is generally understood, that an isostatically pressed product is achieved by isostatically pressing all of its refractory compositions in a single pressing step.

In a further embodiment, the object is achieved by an isostatically pressed product for use in handling of molten metal comprising:

a) a body of cylindrical symmetry made from a first refractory composition;

b) the body comprises a surface;

c) and at least one liner section of cylindrical symmetry applied partially onto the surface of the body; the at least one liner section is made from a second refractory composition;

d) and optionally further liner sections of cylindrical symmetry such as a second liner section applied partially onto the surface of the body; the second liner section is made from a third refractory composition;

e) the at least one liner section/all liner sections forming the liner of the body;

f) whereas the product is of overall cylindrical symmetry and the product comprises a cylindrical axis;

g) and whereas in all half-sections of the product through the cylindrical axis of the product, the intersection of the half-section and the surface of the body in a region covered with the liner, comprises at least one convex and at least two concave sections (as seen from the body);

and whereas the product for use is an isostatically pressed product.

The surface of the body can generally be any surface of the body, such as an outer surface e.g. the surface of a stopper rod or an inner surface, e.g. the inner surface of a submerged entry nozzle.

It is generally understood, that a convex section means that a part of the body is curving out or extending outwardly (as seen from the body), while in a concave section the body is curving in or extending inwardly (as seen from the body). E.g. the intersection can be seen as a mathematical function, which preferably is piecewise defined, the function being in some intervals convex or concave. The mathematical function in these concave or convex intervals can have curved segments or even kinks (e.g. in the form of a step), leading to respective convex or concave segments.

The surface of the body in a region covered with the liner constitutes the interface surface between the body and the liner.

The liner can consist of a single liner section of a single (second) refractory composition (material) or it can consist of multiple liner sections of different refractory compositions (second, third . . . refractory composition). The refractory composition of the liner sections (second, third refractory composition) is different to the refractory composition of the body (first refractory composition).

In one embodiment, the refractory composition of the liner sections (second, third refractory composition) differs from the first refractory composition by at least one of the following properties: the chemical composition (such as e.g. a different carbon content), the mineralogical phase, physical properties (such as e.g. density, porosity, pore size distribution).

In case the liner consists of multiple liner sections, these liner sections may be in contact with each other in any form, e.g. they can even partially or fully overlap, or they can be even totally spaced apart.

The liner can preferably have a varying thickness in the range of 1 mm up to 30 mm, preferably 1 mm to 20 mm. The thickness is to be understood as the distance from the outer surface of the liner to the interface with the body measured in the normal direction to the outer surface of the liner.

In one embodiment the isostatically pressed product for use in handling of molten metals is of cylindrical symmetry. The at least one liner section can be of cylindrical symmetry, preferably the at least one liner section has the form of a toroid.

Preferably the isostatically pressed product for use in handling of molten metal is selected from the group of: a stopper rod, a submerged entry nozzle, a submerged entry shroud, a ladle shroud.

In a further embodiment the isostatically pressed product according to the invention can be configured that in at least one cross-section or half-section of the isostatically pressed product, the surface of the body in a region covered with the liner, comprises at least two convex or at least three concave sections. This further improves adhesion.

In a further embodiment the refractory compositions (50, 51) of the body and the at least one liner section forming the liner of the body form a jointless connection.

In other words, there is no joint (or even gap) between the refractory compositions and the liner. This reduced hot erosion due to a flowing molten metal.

In a further embodiment, all refractory components are isostatically pressed in a single step. In a second embodiment, the object is achieved by providing a method for manufacturing a product for use in handling of molten metal, the product comprising a body with a surface and at least one liner applied at least partially onto the surface of the body, the method comprises the following steps:

a) Placing a first division wall into a mold, such that the lower end of the first division wall is positioned at a first height (h1) above the bottom surface of the mold;

b) Filling a first refractory composition on a first side of the first division wall into the mold;

c) Filling a second refractory composition on a second side of the first division wall into a mold;

d) Removing all division walls from the mold;

e) Pressing the refractory compositions.

Preferably, the method comprises the following steps:

a) Placing a first division wall into a mold, such that the lower end of the first division wall is positioned at a first height (h1) above the bottom surface of the mold;

b) Placing a second division wall into the mold, such that the lower end of the second division wall is positioned at a second height (h2) above the bottom surface of the mold;

c) Filling a first refractory composition on a first side of the first division wall into the mold;

d) Filling a second refractory composition on a second side of the first division wall into a mold (that is on the first side of the second division wall, or in other words between the first and second division wall);

e) Filling a second refractory composition or a third refractory composition on a second side of the second division wall into a mold;

f) Removing all division walls from the mold;

g) Pressing the refractory compositions.

More preferably, the method comprises the following steps:

a) Placing a first division wall in the form of a cylindrical shell into a mold comprising a cylindrical sidewall, such that the first division wall and the cylindrical sidewall of the mold share the same symmetry axis and such that the lower end of the first division wall is positioned at a first height (h1) above the bottom surface of the mold;

b) Filling a first refractory composition on a first side of the first division wall into the mold;

c) Filling a second refractory composition on a second side of the first division wall into a mold;

d) Removing all division walls from the mold;

e) Pressing the refractory compositions.

Most preferably, the method comprises the following steps:

a) Placing a first division wall in the form of a cylindrical shell into a mold comprising a cylindrical sidewall, such that the first division wall and the cylindrical sidewall of the mold share the same symmetry axis and such that the lower end of the first division wall is positioned at a first height (h1) above the bottom surface of the mold;

b) Placing a second division wall in the form of a cylindrical shell into the mold comprising a cylindrical sidewall, such that the second division wall, the first division wall and the cylindrical sidewall of the mold share the same symmetry axis, such that the lower end of the second division wall is positioned at a second height (h2) above the bottom surface of the mold;

c) Filling a first refractory composition on a first side of the first division wall into the mold;

d) Filling a second refractory composition on a second side of the first division wall into a mold;

e) Filling a second refractory composition or a third refractory composition on a second side of the second division wall into a mold;

f) Removing all division walls from the mold;

g) Pressing the refractory compositions.

The method yields a product for use in handling of molten metal, the product comprising a body made from a first refractory material with a surface and at least one liner applied at least partially onto the surface of the body, the liner is made from a second material; or from a second and third material.

Preferably the mold is an isostatic pressing mold and pressing is affected by an isostatic pressing apparatus.

Generally, filling of a (first, second, third) refractory material means that a flowable material is filled into the form. Preferably, any pre-formed shapes for the body and for the liner materials are avoided.

In another embodiment, a third division wall is placed into the mold, such that the lower end of the third division wall is positioned at a third height (h3) above the bottom surface of the mold. Further division walls (such as the second and third division wall) allow to use different materials for each liner sections and they also increase the mechanical stability in the resulting product.

In a further embodiment, the division walls are concentrically arranged cylindrical shells or in other word, all division walls are of cylindrical symmetry and share the same symmetry axis. The symmetrical arrangement is preferable for the pressure distribution during isostatic pressing.

In another embodiment, the first division wall is encircled by the second division wall, and whereas the first height (h1) is larger than the second height (h2). Preferably filling of the first refractory material is done from the center of the first division wall.

In another embodiment, the second division wall is encircled by the first division wall, and whereas the first height (h1) is larger than the second height (h2). Preferably filling of the first refractory material is done from the periphery of the mold.

In another embodiment, the first division wall is encircled by the second division wall, the second division wall is encircled by the third division wall; and whereas the first height (h1) is larger than the second height (h2), which is larger than the third height (h3) of the respective lower end of each division wall above the bottom surface of the mold.

Exemplary embodiments of the invention are explained in more detail by means of illustrations:

FIG. 1 shows a schematic setup during production of a first isostatically pressed product for handling molten metal, such as a stopper rod.

FIG. 2 shows a schematic cross-section of a first isostatically pressed product for handling molten metal, such as a stopper rod.

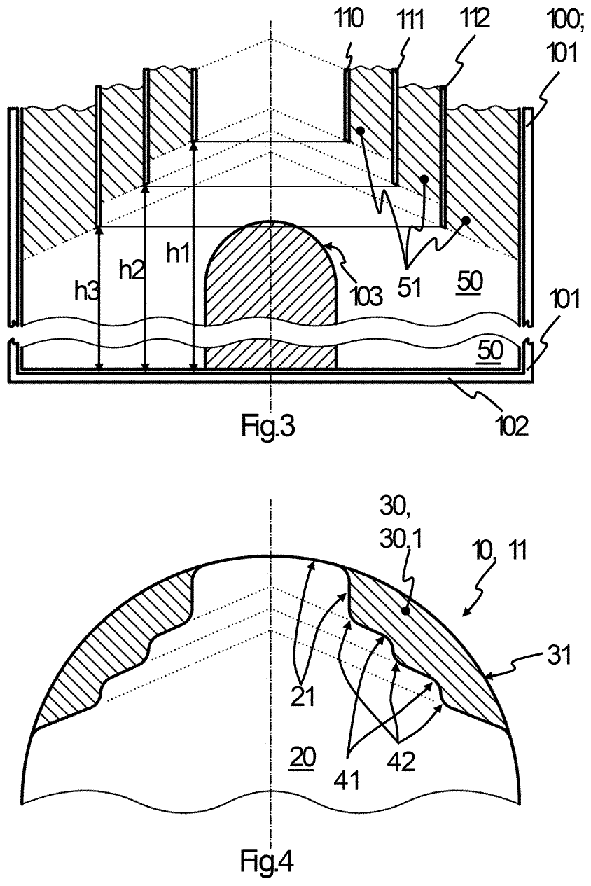

FIG. 3 shows a schematic setup during production of a second isostatically pressed product for handling molten metal, such as a stopper rod.

FIG. 4 shows a schematic cross-section of a second isostatically pressed product for handling molten metal, such as a stopper rod.

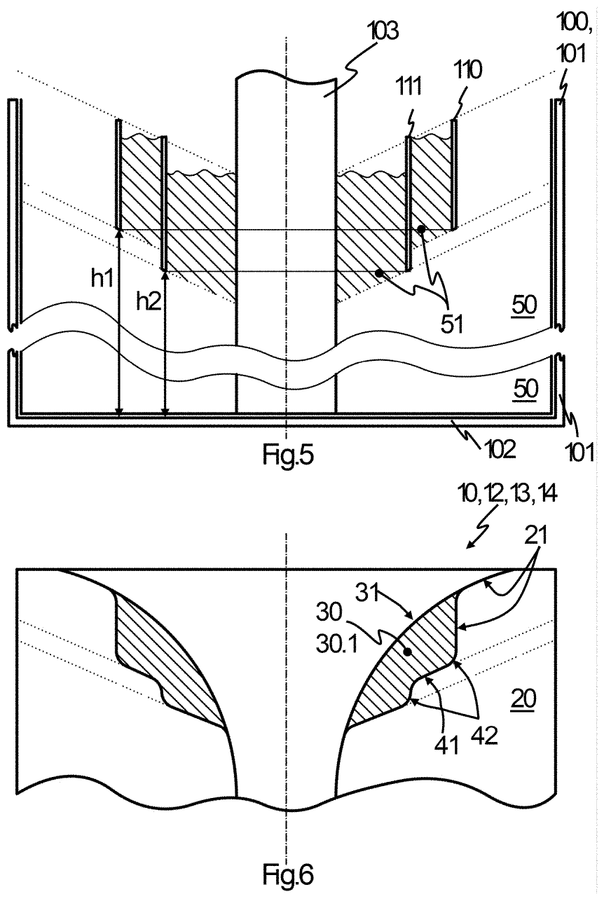

FIG. 5 shows a schematic setup during production of a third isostatically pressed product for handling molten metal, such as a submerged entry nozzle, or a submerged entry shroud, or a ladle shroud.

FIG. 6 shows a schematic cross-section of a third isostatically pressed product for handling molten metal, such as a submerged entry nozzle, or a submerged entry shroud, or a ladle shroud.

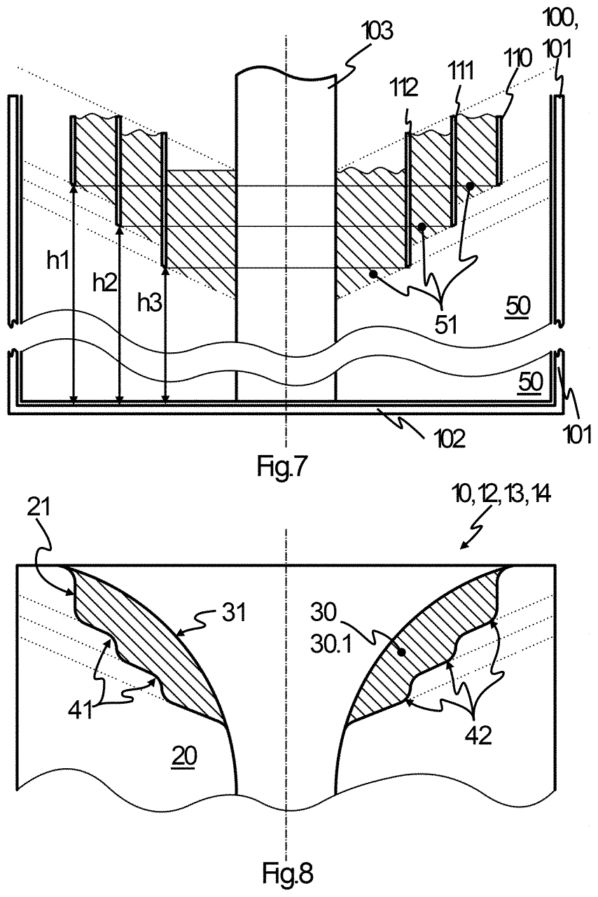

FIG. 7 shows a schematic setup during production of a third isostatically pressed product for handling molten metal, such as a submerged entry nozzle, or a submerged entry shroud, or a ladle shroud.

FIG. 8 shows a schematic cross-section of a third isostatically pressed product for handling molten metal, such as a submerged entry nozzle, or a submerged entry shroud, or a ladle shroud.

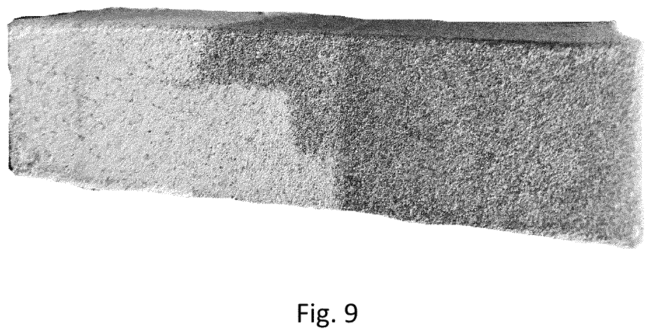

FIG. 9 shows a picture of a test bar produced according to the invention.

FIG. 1 shows a schematic setup during production of a first isostatically pressed product for handling molten metal, such as a stopper rod (11). A mold (100) comprising a cylindrical sidewall (101), and a bottom surface (102), and optionally an inside form (103) of the shape of a mandrel is provided. A first division wall (110) and a second division wall (111) are placed into the mold (100) in a position above the bottom surface (102) of the mold (100). The lower end of the first division wall (110) is positioned at a first height (h1) above the bottom surface (102) of the mold (100) and the lower end of the second division wall (111) is positioned at a second height (h2) above the bottom surface (102) of the mold (100). Here the first division wall (110) is encircled by the second division wall (111), h2<h1, as h1=98 cm and h2 is 97 cm. The first (110) and second (111) division walls are concentrically arranged shells with respective diameters of 7 cm and 9 cm. Their axis coincides with the axis of the cylindrical sidewall (101) of the mold (the axis is shown by the vertical dot shaped line in FIG. 1), the cylindrical sidewall (101) of the mold (100) has a diameter of 13 cm. A first refractory composition (50) with a first chemical composition is filled into the mold through the first division wall (110), that is through/near its axis. The refractory composition (50) flows into the mold (100) and is constrained within the sidewall (101) of the mold (100). Optionally, an inside form (103) can be present in the lower part of the mold (100). Inside the sidewall (101) the first refractory composition (50) builds a cone with a repose angle/angle of repose, which is the steepest angle at which a sloping surface formed of loose material is stable. This angle is shown in FIG. 1 for different filling heights (see doted sloped lines). When the cone reaches a certain height, the first refractory composition (50) is constrained within the second division wall (111). Now this constrained cone builds up inside the second division wall (111) until at a certain height where the first refractory composition (50) is constrained within the first division wall (110), where it can be filled up to the top. Then a second refractory composition (51) with a second chemical composition is filled on a second side of the first division wall (110), that is into the (free/unfilled) space formed between the first (110) and second (111) division wall. The same second refractory composition (51) with a second chemical composition is filled on a second side of the second division wall (111), that is into the (free/unfilled) space formed between the second division wall (111) and the sidewall (101) of the mold (100). Subsequently, the first (110) and second (111) division walls are removed by pulling the walls (110, 111) vertically out of the refractory compositions (50, 51). The refractory compositions (50, 51) fill the (thin) voids where the walls (110, 111) have been before. The mold is then closed on the top and the refractory compositions (50, 51) are isostatic pressed. FIG. 2 shows a cross-section of an isostatically pressed product (10, 11) obtained by this production of a first isostatically pressed product. It shows a stopper head of a stopper rod (11), with a cylindrical body (20) made from a first refractory composition (50) and a cylindrical liner (30) (in the form of a toroid) with a first (cylindrical) liner section (30.1) made from a second refractory composition (51). The liner section (30.1), forming the liner (30), is applied partially onto the surface (21) of the body (20). The region where the liner (30) covers the surface (21) of the body (20) defines an interface region. The cross-section through the cylindrical axis (vertical dot-dashed line) of FIG. 2 shows that the surface (21) of the body (20) in the region covered with the liner (30) has one convex (41) and two concave (42) sections as seen from the body (20). These sections for interlocking the body and the liner can be formed by curved intersections (as shown in the figure) or alternatively as sections with steps (40) (not shown in the figures). The part of FIG. 2 on the right side of the cylindrical axis (that is the vertical dot-dashed line) represents a half-section of the isostatically pressed product (10, 11) through its cylindrical axis, the intersection of the half-section and the surface (21) of the body (20) in a region covered with the liner (30), has one convex (41) and two concave (42) sections as seen from the body (20). The part of FIG. 2 on the left side of the cylindrical axis (that is the vertical dot-dashed line) represents a front view of the isostatically pressed product (10,11), with the (outer) surface of the body (21) and a liner (30). The outer surface of the liner (30) achieved a liner section that covers 50% of the total surface of the stopper nose geometry and has a maximum thickness of 10 mm.

FIG. 3 shows a schematic setup during isostatically pressed production of a second isostatically pressed product for handling molten metals, such as a stopper rod (11). The setup is similar as already discussed for FIG. 1 with the exception, that an additional third division wall (112) is placed into the mold (100) in a position above the bottom surface (102) of the mold (100). The lower end of the third division wall (112) is positioned at a third height (h3) above the bottom surface (102) of the mold (100). Here the first division wall (110) is encircled by the second division wall (111), which is encircled by the third division wall (112), h3<h2<h1, as h1=98 cm, h2=97 cm and h3=95 cm. The first (110), second (111) and third (112) division walls are concentrically arranged shells. Their axis coincides with the axis of the cylindrical sidewall (101) of the mold (the axis is shown by the vertical dot shaped line in FIG. 3). Filling of the first refractory composition (50) is similar as already described for the first isostatically pressed product (FIG. 2). Further, in one example, the first refractory composition (50) and the second refractory composition (51) have the same chemical composition but have a different porosity. The second refractory composition (51) is filled on a second side of the first division wall (110), that is into the space formed between the first (110) and second (111) division wall. The same second refractory composition (51) is filled on a second side of the second division wall (111), that is into the space formed between the second division wall (111) and the third division wall (112). The same second refractory composition (51) is filled on a second side of the third division wall (112), that is into the space formed between the third division wall (112) and the sidewall (101) of the mold (100). Removal of the division walls and further pressing is performed as described with the first isostatically pressed product. The cross-section through the cylindrical axis (vertical dot-dashed line) of the obtained isostatically pressed product in FIG. 4 shows that the surface (21) of the body (20) in the region covered with the liner (30) has two convex (41) and three concave (42) sections, as seen from the body. These sections for interlocking the body and the liner can be formed by curved intersections (as shown in the figure) or alternatively as sections with steps (40) (not shown in the figures). The part of FIG. 4 on one side of the cylindrical axis (that is the vertical dot-dashed line) represents a half-section of the isostatically pressed product (10, 11) through its cylindrical axis, the intersection of the half-section and the surface (21) of the body (20) in a region covered with the liner (30), has two convex (41) and three concave (42) sections, as seen from the body. The outer surface of the liner achieved a liner section that covers 75% of the total surface of the stopper nose geometry and has a maximum thickness of 1 cm.

In an alternative example of the one discussed in connection with FIG. 3 (not separately shown in the figures), instead of the second compositions (51), a third refractory composition (52) with a different chemical composition is filled on a second side of the second division wall (111). Therefore the resulting liner (30) consists of three liner sections (30.1, 30.2, 30.3), whereas the first (30.1) and third (30.3) liner sections are made from the second refractory composition (51), whereas the second liner section (30.2) is made from the third refractory composition (52).

FIG. 5 shows a schematic setup during production of a third isostatically pressed product for handling molten metals, such as a ladle shroud (14). A mold (100) with a cylindrical sidewall (101) and an inside form (103) of the shape of a mandrel is provided and a bottom surface (102). A first division wall (110) and a second division wall (111) are placed into the mold (100) in a position above the bottom surface (102) of the mold (100). The lower end of the first division wall (110) is positioned at a first height (h1) above the bottom surface (102) of the mold (100) and the lower end of the second division wall (111) is positioned at a second height (h2) above the bottom surface (102) of the mold (100). Here the second division wall (111) is encircled by the first division wall (110), h1>h2, as h1=99 cm and h2 is 98 cm. The first (110) and second (11) division walls are concentrically arranged shells with respective diameters of 9 cm and 7 cm. Their axis coincides with the axis of the cylindrical sidewall (101) of the mold (the axis is shown by the vertical dot shaped line in FIG. 5), the cylindrical sidewall (101) of the mold (100) has a diameter of 13 cm. A first refractory composition (50) with a first carbon content is filled into the mold (uniformly) along the inside of the cylindrical sidewall (101) (and outside of the first division wall (110)), that is through/near its periphery. The refractory composition (50) flows into the mold (100) and is constrained within the sidewall (101) and the inside form (103) of the mold (100). Inside the sidewall (101) the first refractory composition (50) builds a negative cone with a repose angle/angle of repose, which is the steepest angle at which a sloping surface formed of loose material is stable. This angle is shown in FIG. 5 for different filling heights (see doted sloped lines). When the negative cone reaches a certain height, the first refractory composition (50) is constrained within the second division wall (111). Now this constrained negative cone builds up outside the second division wall (111), until at a certain height, after which the first refractory composition (50) is constrained within the first division wall (110), where it can be filled up to the top outside the first division wall (110). Then a second refractory composition (51) with lower carbon content is filled on a second side of the first division wall (110), that is into the space formed between the first division wall (110) and the second division wall (111). The same second refractory composition (51) with a lower carbon content is filled on a second side of the second division wall (111), that is into the space formed between the second division wall (111) and the inside form (103). Subsequently, the first (110) and second (111) division walls are removed by pulling the walls (110, 111) vertically out of the refractory compositions (50, 51). The refractory compositions (50, 51) fill the (thin) voids where the walls (110, 111) have been before. The mold is then closed on the top and the refractory compositions (50, 51) were isostatic pressed. FIG. 6 shows a cross-section of a isostatically pressed product (10, 14) obtained by this production of a third isostatically pressed product. It shows a nozzle of a ladle shroud (14), with a cylindrical body (20) made from a first refractory composition (50) and a cylindrical liner (30) (in the form of a toroid) with a first (cylindrical) liner section (30.1) made from a second refractory composition (51). The liner section (30.1), forming the liner (30), is applied partially onto the inner surface (21) of the body (20). In the region where the liner (30) covers the surface (21) of the body (20) defines in interface region. The cross-section through the cylindrical axis (vertical dot-dashed line) of FIG. 6 shows that the surface (21) of the body (20) in the region covered with the liner (30) has one convex (41) and two concave (42) sections. These sections for interlocking the body and the liner can be formed by curved intersections (as shown in the figure) or alternatively as sections with steps (40) (not shown in the figures). The part of FIG. 6 on one side of the cylindrical axis (that is the vertical dot-dashed line) represents a half-section of the isostatically pressed product (10, 14) through its cylindrical axis, the intersection of the half-section and the surface (21) of the body (20) in a region covered with the liner (30), has one convex (41) and two concave (42) sections. The outer surface of the liner achieved a liner section that covers 50% of the total surface of the seat area of the nozzle and has a maximum thickness of 1 cm.

FIG. 7 shows a schematic setup during production of a fourth isostatically pressed product for handling molten metals, such as a ladle shroud (14). The setup is similar as already discussed for FIG. 5 with the exception, that an additional third division wall (112) is placed into the mold (100) in a position above the bottom surface (102) of the mold (100). The lower end of the third division wall (112) is positioned at a third height (h3) above the bottom surface (102) of the mold (100). Here the third division wall (112) is encircled by the second division wall (111), which is encircled by the first division wall (110), h1>h2>h3, as h1=98 cm, h2=97 cm and h3=95 cm. The first (110), second (111) and third (112) division walls are concentrically arranged shells. Their axis coincides with the axis of the cylindrical sidewall (101) of the mold (the axis is shown by the vertical dot shaped line in FIG. 7). Filling of the first refractory composition (50) is similar as already described for the third isostatically pressed product (FIG. 5). Further, in one example, a second refractory composition (51) with a different density is filled on a second side of the first division wall (110), that is into the space formed between the first division wall (110) and the second division wall (111). The same second refractory composition (51) with a different density is filled on a second side of the second division wall (111), that is into the space formed between the second division wall (111) and the third division wall (112). The same second refractory composition (51) with a different density is filled on a second side of the third division wall (112), that is into the space formed between the third division wall (112) and the inside form (103). Removal of the division walls and further pressing is performed as described with the third isostatically pressed product. The cross-section through the cylindrical axis (vertical dot-dashed line) of the obtained isostatically pressed product in FIG. 8 shows that the surface (21) of the body (20) in the region covered with the liner (30) has two convex (41) and three concave (42) sections. These sections for interlocking the body and the liner can be formed by curved intersections (as shown in the figure) or alternatively as sections with steps (40) (not shown in the figures). The part of FIG. 8 on one side of the cylindrical axis (that is the vertical dot-dashed line) represents a half-section of the isostatically pressed product (10, 14) through its cylindrical axis, the intersection of the half-section and the surface (21) of the body (20) in a region covered with the liner (30), has two convex (41) and three concave (42) sections.

In an alternative example of the one discussed in connection with FIG. 7 (not separately shown in the figures), instead of the second compositions (51), a third refractory composition (52) with different chemical composition is filled on a second side of the second division wall (111). Therefore the resulting liner (30) consists of three liner sections (30.1, 30.2, 30.3), whereas the first (30.1) and third (30.3) liner sections are made from the second refractory composition (51), whereas the second liner section (30.2) is made from the third refractory composition (52).

FIG. 9 shows an image of a test bar produced with the method according to the invention. Such test bars were produced to evaluate the bending strength, including the strength of the interface. The test bar shown in FIG. 9 was made from a first refractory material and a second refractory material. Similar test bars were manufactured from solely the first refractory material, and solely the second refractory material. The test bars made from only one material showed a bending strength of 5.83 MPa and 7.83 MPa respectively. The test bar from FIG. 9 achieved a bending strength of 6.75 Mpa, which is in the middle of the two pure materials. This shows that the interface indeed shows very good mechanical properties, and the two refractory materials show very good adhesion to each other.

### LIST OF REFERENCE NUMERALS AND FACTORS (GERMAN TRANSLATION IN PARENTHESIS)

10 Isostatically pressed product for use in handling of molten metals
11 Stopper rod
12 Submerged entry nozzle
13 Submerged entry shroud
14 Ladle shroud
20 Body
21 Surface of the body
30 Liner
30.1 First liner section
30.2 Second liner section
30.3 Third liner section
31 Outer surface of liner (30)
40 Step
41 Convex section
42 Concave section
50 First refractory composition
51 Second refractory composition
52 Third refractory composition
100 Mold
101 Sidewall of mold
102 Bottom surface of mold
103 Inside form of mold
110 First division wall
111 Second division wall
112 Third division wall
h1 First height of first division wall (110) above the bottom surface (102) of the mold (100)
h2 Second height of second division wall (111) above the bottom surface (102) of the mold (100)
h3 Third height of third division wall (112) above the bottom surface (102) of the mold (100)

1. An isostatically pressed product (10, 11, 12, 13, 14) for use in handling of molten metals comprising:
1.1 a body (20) made from a first refractory composition (50);
1.2 the body (20) comprises a surface (21);
1.3 and at least one liner section (30.1) applied partially onto the surface (21) of the body (20); the at least one liner section (30.1) is made from a second refractory composition (51);
1.4 the at least one liner section (30.1, 30.2) forming a liner (30) of the body (20);
1.5 whereas in at least one cross-section of the product (10, 11, 12, 13, 14), the surface (21) of the body (20) in a region covered with the liner (30) comprises at least one convex (41) and at least two concave (42) sections;
1.6 whereas the product (10, 11, 12, 13, 14) is an isostatically pressed product.

2. Isostatically pressed product (10, 11, 12, 13, 14) according to claim 1, characterized in that the at least one liner section (30.1, 30.2) is of cylindrical symmetry.

3. Isostatically pressed product (10, 11, 12, 13, 14) according to claim 1, characterized in that the isostatically pressed product (10, 11, 12, 13, 14) for use in handling of molten metals is of cylindrical symmetry.

4. Isostatically pressed product (10, 11, 12, 13, 14) according to claim 1, characterized in that the at least one liner section (30.1, 30.2) has the form of a toroid.

5. Isostatically pressed product (10, 11, 12, 13, 14) according to claim 2, characterized in that in a half-section of the isostatically pressed product (10, 11, 12, 13, 14) through an axis of symmetry of the product, an intersection of the half-section and the surface (21) of the body (20) in a region covered with the liner (30), comprises at the least one convex (41) and at least two concave (42) sections.

6. Isostatically pressed product (10, 11, 12, 13, 14) according to claim 1, characterized in that the isostatically pressed product (10, 11, 12, 13, 14) for use in handling of molten metals is selected from the group of: a stopper rod (11), a refractory nozzle, a submerged entry shroud (13), or a ladle shroud (14).

7. Isostatically pressed product (10, 11, 12, 13, 14) according to claim 1, characterized in that in the at least one cross-section or in at least one half-section of the isostatically pressed product (10, 11, 12, 13, 14), the surface (21) of the body (20) in a region covered with the liner (30), comprises at least two convex or at least three concave sections.

8. Isostatically pressed product (10, 11, 12, 13, 14) according to claim 1, characterized in that refractory compositions (50, 51) of the body (20) and the at least one liner section (30.1, 30.2) forming the liner (30) of the body (20) form a jointless connection.

9. Method for manufacturing a product (10, 11, 12, 13, 14) for use in handling of molten metals, the product comprising a body (20) with a surface (21) and at least one liner (30) applied at least partially onto the surface (21) of the body (20), the method comprises the following steps:
9.1 placing a first division wall (110) into a mold (100), such that a lower end of the first division wall (110) is positioned at a first height (h1) above a bottom surface (102) of the mold (100);
9.2 filling a first refractory composition (50) on a first side of the first division wall (110) into the mold (100);
9.3 filling a second refractory composition (51) on a second side of the first division wall (110) into the mold (100);
9.4 removing the first division wall (110) from the mold (100); and
9.5 pressing the refractory compositions (50, 51).

10. Method according to claim 9, characterized in that the mold is an isostatic pressing mold and pressing is affected by an isostatic pressing apparatus.

11. Method according to claim 17, characterized in that a third division wall (112) is placed into the mold (100), such that a lower end of the third division (112) wall is positioned at a third height (h3) above the bottom surface (102) of the mold (100).

12. Method according to claim 17, characterized in that the first division wall (110) and the second division wall (111) are concentrically arranged cylindrical shells and the mold (100) comprises a cylindrical sidewall (101).

13. Method according to claim 17, characterized in that the first division wall (110) and the second division wall (111) are of cylindrical symmetry and share a symmetry axis.

14. Method according to claim 11, characterized in that the first division wall (110) is encircled by the second division wall (111), the second division wall (111) is encircled by the third division wall (112); and whereas the second height (h2) of the second division wall (111) lies between the first height (h1) of the first division wall (110) and the third height (h3) of the third division wall (112) above the bottom surface (102) of the mold (100).

15. Product for use in handling molten metals, the product obtained by performance of a process, the process comprising:
placing a first division wall (110) into a mold (100), such that a lower end of the first division wall (110) is positioned at a first height (h1) above a bottom surface (102) of the mold (100);
filling a first refractory composition (50) on a first side of the first division wall (110) into the mold (100);
filling a second refractory composition (51) on a second side of the first division wall (110) into the mold (100);
removing the first division wall (110) from the mold (100); and
pressing the refractory compositions (50, 51).

16. The isostatically pressed product (10, 11, 12, 13, 14) of claim 1, wherein the body (20) and the at least one liner section (30.1) are isostatically pressed in a single step.

17. Method according to claim 9, further comprising:
placing a second division wall (111) into the mold (100), such that a lower end of the second division wall (111) is positioned at a second height (h2) above the bottom surface (102) of the mold (100).

18. Method according to claim 17, further comprising:
filling the second refractory composition (51) or a third refractory composition (52) on a second side of the second division wall (111) into the mold.

19. Product according to claim 15, the process further comprising:
placing a second division wall (111) into the mold (100), such that a lower end of the second division wall (111) is positioned at a second height (h2) above the bottom surface (102) of the mold (100).

20. Product according to claim 19, the process further comprising:
filling the second refractory composition (51) or a third refractory composition (52) on a second side of the second division wall (111) into the mold (100).
